(19) United States
(12) Patent Application Publication
(10) Pub. No.: US 2026/0165517 A1
(43) Pub. Date: Jun. 18, 2026

(54) Cutlery with Integrated Structural Reinforcement

(71) Applicant: Khaled M. SHAHRIAR, New Hyde Park, NY (US)

(72) Inventor: Khaled M. SHAHRIAR, New Hyde Park, NY (US)

(21) Appl. No.: 19/373,524

(22) Filed: Oct. 29, 2025

Related U.S. Application Data
(60) Provisional application No. 63/729,234, filed on Dec. 6, 2024.

(51) Int. Cl. A47G 21/02; A47G 21/04; B26B 3/02; B26B 9/02

(52) U.S. Cl. CPC A47G 21/023; A47G 21/04; B26B 3/02; B26B 9/02; A47G 2400/10

(57) ABSTRACT

A fork/spoon includes a head portion, a handle portion, and a raised ridge structure extending along a back side of the cutlery from the head portion to the handle portion. The ridge structure includes a bifurcated Y-shaped portion located within the head portion and merging into a single longitudinal ridge extending along the handle portion. A knife is also provided, which includes a blade portion having one side defining a cutting edge and an opposite lateral side, a handle portion extending from the blade portion, and a raised ridge structure extending along the blade portion and the handle portion.

### BACKGROUND

This invention pertains to the field of moldable product design, particularly to disposable and reusable cutlery.

Designs for conventional plastic cutlery, including forks, knives, and spoons, often crack or fail under pressure, particularly in areas subjected to concentrated forces, such as the handle or connection points between the handle and functional parts (e.g., fork prongs or spoon bowls). Attempts to increase durability by adding material result in heavier, less eco-friendly designs that increase manufacturing costs and environmental impact.

There remains a need for more material-efficient plastic cutlery that provides equivalent strength and durability while reducing plastic consumption.

### SUMMARY OF THE INVENTION

The present invention provides an improved utensil structure incorporating an integral reinforcing ridge, configured to enhance mechanical strength and durability while reducing material consumption. The utensil may be formed as a spoon, fork, or knife, each having a head portion and an elongated handle portion molded as a single continuous body.

In one aspect of the invention, the utensil comprises a head portion having a curved and enlarged configuration and an elongated handle extending from the head portion. A raised ridge structure extends along a back side of the utensil from the head portion through at least part of the handle. The ridge structure includes a bifurcated Y-shaped portion located within the head portion, which merges into a single longitudinal ridge extending along the handle. The ridge functions as a reinforcing spine that redistributes stress and improves rigidity without adding excess material thickness.

In certain embodiments, the utensil is integrally formed as a single molded body, ensuring uniform strength and minimizing assembly requirements. The ridge structure may extend over at least one-fourth of the handle length from the head portion, providing continuous reinforcement across the utensil. The handle may include a peripheral rim having greater wall thickness than an interior region of the handle to enhance stiffness and reduce flexural deformation while conserving material. The ridge structure is preferably centered along the longitudinal axis of the utensil for symmetrical load distribution.

In embodiments where the utensil is a spoon, the head portion defines a bowl-shaped region, with the Y-shaped ridge portion positioned near the proximal end of the bowl to strengthen the transition between the bowl and handle. In embodiments where the utensil is a fork, the head portion includes a plurality of tines extending from a curved base region, and each tine may include a reinforcing ridge extending along its length and connecting with an upper branch of the Y-shaped ridge structure, thereby enhancing stiffness and preventing tine deflection during use.

In another aspect, the invention provides a knife having a head (or blade) portion and a handle portion integrally formed as a single molded body. The blade portion includes a first lateral side defining a cutting edge, which may be serrated, and a second lateral side opposite the first. A raised ridge structure extends along both the blade and handle. The ridge structure of the knife can include a primary ridge extending obliquely from the second lateral side of the blade toward the first lateral side of the handle. In certain embodiments, a secondary ridge is disposed near a junction between the blade and handle and joins the primary ridge at an acute angle. A third ridge may also be provided along the handle portion, intersecting the primary ridge at a location spaced from the secondary ridge. This network of ridges strengthens the knife against bending and torsional loads that arise during cutting, improving the stability and durability of the blade-handle connection.

The knife may also include a peripheral rim of greater wall thickness than the interior of the handle for improved stiffness and comfort. In some embodiments, the ridge structures are disposed symmetrically on both the front and back sides of the knife and are aligned along a central longitudinal plane, ensuring balanced resistance to twisting forces. The cutting edge may optionally include a serrated edge to facilitate slicing actions.

Across all embodiments, the integrated ridge structure can achieve superior structural performance while significantly reducing usage of material of construction. The result is a family of lightweight, durable, and environmentally responsible utensils (which can be disposable or reusable) that can be manufactured by standard injection molding without modification to conventional tooling.

### BRIEF DESCRIPTION OF THE DRAWINGS

FIGS. 1A-1C show structure of a spoon according to certain embodiments of the present disclosure; FIG. 1D illustrates the function of the ridge structure of the spoon.

FIGS. 2A-2C show structure of a fork according to certain embodiments of the present disclosure; FIG. 2D illustrates the function of the ridge structure of the fork.

FIGS. 3A-3C show structure of a knife according to certain embodiments of the present disclosure; FIG. 3D illustrates the function of the ridge structure of the knife.

### DETAILED DESCRIPTION

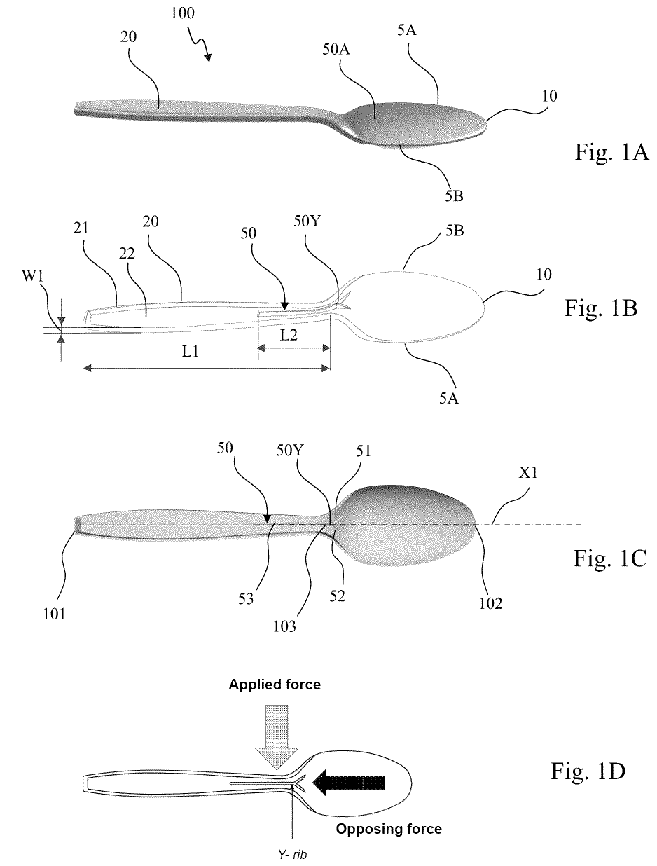

The invention will now be described in detail with reference to FIGS. 1A through 3D, which illustrate representative embodiments of the disclosed cutlery. While the embodiments shown relate to a spoon, fork, and knife, it will be understood that the structural principles described herein are applicable to other forms of molded utensils and similar elongated articles. Dimensions and proportions may be varied to achieve desired strength-to-weight characteristics without departing from the scope of the invention as defined by the appended claims.

In an aspect, the invention provides a cutlery structure, including spoons, forks, and knives, formed as a single molded body incorporating an integral ridge or rib structure. The ridge structure can reinforce the utensil against bending and cracking while reducing material consumption.

The utensils of the present invention may be formed from common synthetic plastics such as polystyrene and polypropylene, or biodegradable materials such as polylactic acid (PLA), corn starch, etc., as well as other synthetic or bio-based polymers suitable for injection molding, including but not limited to thermoplastic resins, elastomeric polymers, composite materials, and blends thereof.

As used herein, the term ridge or rib refers to a raised reinforcement projecting from a surface of the utensil. The ridge structure may take the form of a Y-shaped or Y-type rib having a longitudinal stem extending along the handle and bifurcating into two angled branches within the utensil's functional head portion.

This configuration enables improved load dispersion and impact dissipation, providing enhanced strength without the need for thickened wall sections. The Y-type ridge structure provides several benefits:

Dispersing applied forces: The bifurcated configuration evenly distributes bending stress across the utensil body, minimizing weak points that lead to cracking.

Dissipating impact loads: The branching geometry redirects sudden impact forces through multiple paths, reducing localized strain energy and preventing catastrophic failure.

Enhancing crack resistance: The ribs reinforce stress-prone transition zones, diverting stress away from critical areas and inhibiting crack initiation or propagation.

Optimizing material usage: By strategically reinforcing only key regions, the design allows non-critical wall sections to be thinned, reducing material by approximately 50-60 %, e.g., compared with conventional 9.2-10 g utensils of similar performance, achieving equivalent strength at a weight of about 4.0-4.2 g.

The ridge configuration therefore provides a lightweight, high-strength, and sustainable cutlery solution.

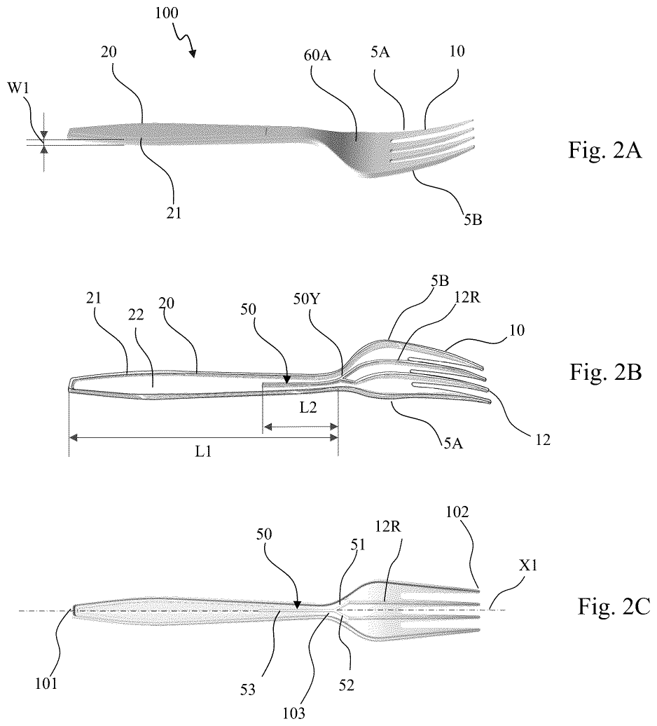

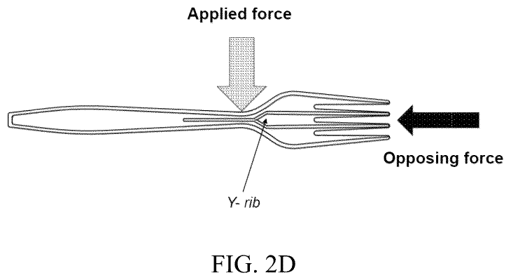

Referring to FIGS. 1A-2D, the ridge structure 50 for the spoon/fork is located on the back side of the utensil 5B (where the bowl of the spoon or the curved region of the fork has a convex outer surface, opposing to its front side 5A) generally comprises a central longitudinal stem (53) extending along a mid-section of the utensil handle (10) and bifurcating into two upwardly diverging arms or upper branches (51, 52) forming a Y-shaped bifurcation (50Y) within the functional portion (e.g., spoon bowl or fork base). The upper branches extend outward at an angle, e.g., between 30° and 75°, to transmit and redistribute stress evenly across adjacent areas of the head portion.

A first embodiment of the utensil, shown in FIGS. 1A-1C, is a spoon (100) including a head portion (10) defining a bowl (50A) and an elongated handle (20) extending along a longitudinal axis (X1). The handle includes a peripheral rim (21) having a greater wall thickness W1 than that of an interior region (22). The spoon defines a proximal end 101 (also the end of the handle) and a distal end 102 (also the tip of the bowl).

A raised ridge structure (50) extends along the back side (5B) of the spoon from the bowl (50A) through the handle (20). The ridge includes the bifurcated Y-shaped portion (50Y) with first and second upper branches (51, 52) merging into a central longitudinal stem (53) that continues along the handle. The Y-bifurcation is located proximate to the proximal end (103) of the bowl region, reinforcing the transition between the head and handle. The ridge extends into the handle for a length L2 relative to the total handle length L1, preferably reaching at least one-fourth, or at least a third, of the handle length L1.

As illustrated in FIG. 1D, the ridge structure channels and balances these opposing forces by dispersing stress laterally through the bifurcated branches (51, 52) and longitudinally through the stem (53). This balanced load path reduces bending deflection and reduce the likelihood of fracture at the bowl-to-handle junction.

A second embodiment of the utensil (100), illustrated in FIGS. 2A-2C, is a fork having a head portion 10 including a curved base region (60A) and a plurality of tines (12) extending therefrom. The fork defines a proximal end 101 (also the end of the handle) and a distal end 102 (also the tip of the tines). The ridge structure (50) again includes the Y-shaped bifurcation (50Y) located proximate to the proximal end (103) of the base region, with upper branches (51, 52) extending into the base of the fork. Each tine 12 includes a reinforcing ridge (12R) that aligns with and connects to an upper branch of the Y-bifurcation, thereby distributing applied forces from the tines back toward the handle 20. This configuration can withstand cutting and pressing actions and avoid or reduce permanent deformation or breakage of the tines.

As with the spoon embodiment, the handle's peripheral rim (21) can be thicker than the interior region (22), providing stiffness while minimizing material. The ridge structure can be centered along the longitudinal axis (X1) of the utensil for symmetrical load transfer.

As shown in FIG. 2D, an applied force on the fork and an opposing force create stress at the junction of the head portion and the handle portion. The Y-rib redirects these forces along multiple pathways, preventing the tines from twisting or snapping. The arms of the rib act as stress dissipaters, channeling forces toward the handle and thereby maintaining structural integrity during cutting or spearing motions.

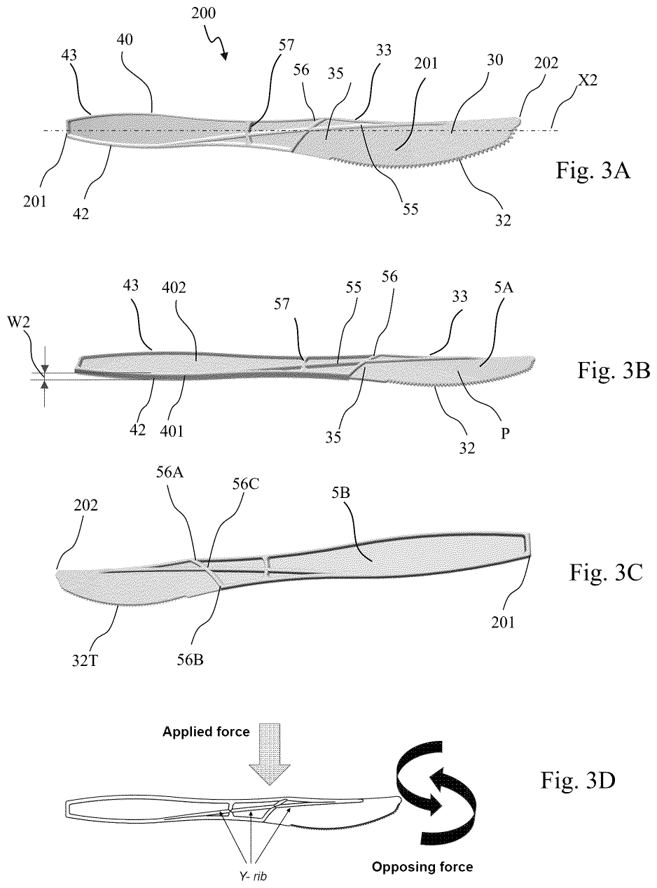

Referring to FIGS. 3A-3C, a third embodiment of the invention provides a knife (200) comprising a head or blade portion (30) and an integrally formed handle portion (40). The blade portion includes a first lateral side defining a cutting edge (32) that may include serrated teeth (32T), and an opposing second lateral side (33). The handle portion includes first and second lateral sides (42, 43) extending from the corresponding lateral sides of the blade portion. The knife defines a proximal end (201, also the end of the handle) and a distal end (202, also the tip of the blade).

A ridge structure extends along a front side of the knife and includes a primary ridge (55) extending obliquely (relative to the longitudinal axis X2 of the fork) from the second lateral side (33) of the blade portion toward the first lateral side (42) of the handle. A secondary ridge (56) is disposed near the junction (35) between the blade and handle and intersects the primary ridge (55) at an acute angle. An upper end 56A of the secondary ridge (56), located adjacent the second lateral side of the junction, lies closer to the blade tip (202) than its lower end 56B. The secondary ridge could also terminate at the point 56C where it meets the primary ridge (55), i.e., without the portion between 56C and 56B as shown. A third ridge (57) extends along the handle portion and intersects the primary ridge (55) at a location spaced from the secondary ridge and closer to the proximal end (201) of the knife.

These intersecting ridges collectively reinforce the knife against torsional and bending loads encountered during slicing. As shown in FIG. 3A-3C, the ridge structure may be provided on both front side 5A and back side 5B of the knife, arranged symmetrically about a central longitudinal plane P (which lies parallel to a major surface of the blade portion).

The handle portion 40 can include a peripheral rim 401 having a wall thickness W2 greater than that of its interior region 402, increasing stiffness while maintaining ergonomic comfort.

In FIG. 3D, the diagram shows how an applied downward cutting force on the blade generates an opposing reaction force and a torsional moment that tends to swing the blade sideways. The diagonal orientation of the Y-rib structure counteracts this torsion by redistributing the opposing forces along intersecting load paths, maintaining alignment of the blade and preventing lateral flexing. The symmetry of the rib arrangement about the central plane further balances twisting forces.

The ridge structure can be incorporated directly into the mold cavity, permitting manufacture by conventional injection molding without additional components or assembly.

The height and width of the ridge structure may be varied according to the type of the material used and the overall dimensions of the utensil. In general, and without limitation, the ridge may have a height and/or width in the range of about 0.5 mm to 3 mm, e.g., from about 1 mm to 1.5 mm, depending on the desired stiffness and molding characteristics. The cross-sectional profile of the ridge may be rectangular, square, triangular, or of another suitable geometry for designed strength and moldability. The height and/or width of the ridge structure may also vary along its length. For example, in the spoon embodiment illustrated in FIGS. 1B-1C, the upper branches of the ridge structure gradually taper toward their distal ends, providing a smooth transition into the surrounding surface and facilitating balanced stress distribution and improved mold release.

Because the rib geometry provides localized reinforcement, wall sections elsewhere in the utensil can be substantially thinner than in traditional designs, achieving the same bending strength with markedly reduced material use. This results in a lighter, more sustainable, and cost-efficient product.

1. A utensil comprising:
a head portion having a curved and enlarged configuration;
an elongated handle extending from the head portion; and
a raised ridge structure extending along a back side of the utensil from the head portion to the handle, the ridge structure including a bifurcated Y-shaped portion located within the head portion and merging into a single longitudinal ridge extending along the handle.

2. The utensil of claim 1, which is integrally formed as a single molded body.

3. The utensil of claim 1, wherein the ridge structure extends to at least a fourth of the length of the handle from the head portion.

4. The utensil of claim 1, wherein the handle includes a peripheral rim having a greater wall thickness than that of an interior region of the handle.

5. The utensil of claim 1, wherein the ridge structure is centered along a longitudinal axis of the utensil.

6. The utensil of claim 1, wherein the bifurcated Y-shaped portion is located near a proximal end of the head portion.

7. The utensil of claim 1, wherein the head portion comprises a bowl-shaped region.

8. The utensil of claim 1, wherein the head portion comprises a plurality of tines extending from a curved base region.

9. The utensil of claim 8, wherein each of the plurality of tines comprises a reinforcing ridge extending along the tine and connecting with an upper branch of the Y-shaped ridge structure.

10. The utensil of claim 1, wherein the utensil is formed by a synthetic plastic or a biodegradable material.

11. A knife having a front surface and back surface, comprising:
a blade portion having a first lateral side defining a cutting edge and a second lateral side opposite the first lateral side;
a handle portion extending from the blade portion, the handle portion having a first lateral side extending from the first lateral side of the blade portion, and a second lateral side extending from the second lateral side of the blade portion; and
a raised ridge structure extending along of the blade portion and the handle portion, wherein the ridge structure includes a primary ridge extending obliquely from the second lateral side of the blade portion toward the first lateral side of the handle portion.

12. The knife of claim 11, further comprising a secondary ridge disposed near a junction between the blade portion and the handle portion and intersecting the primary ridge.

13. The knife of claim 12, further comprising a third ridge disposed on the handle portion and intersecting the primary ridge at a location spaced from the secondary ridge.

14. The knife of claim 11, wherein the handle portion includes a peripheral rim having a greater wall thickness than an interior region of the handle portion.

15. The knife of claim 11, wherein the knife is integrally formed as a single molded body.

16. The knife of claim 11, wherein the cutting edge comprises a serrated edge.

17. The knife of claim 11, wherein the ridge structure is disposed on both the front and back sides of the knife and is symmetrical relative to a central longitudinal plane of the knife.

18. The knife of claim 12, wherein the secondary ridge extends obliquely relative to the handle portion and intersects the primary ridge at an acute angle, and wherein an upper end of the secondary ridge, located adjacent the second lateral side of the blade portion, is positioned closer to a tip of the blade than a lower end of the secondary ridge.

19. The knife of claim 11, wherein the knife is formed by a synthetic plastic or a biodegradable material.
